(19) United States
(12) Patent Application Publication
(10) Pub. No.: US 2010/0090955 A1
(43) Pub. Date: Apr. 15, 2010

(54) MOUSE HAVING SCROLLING FUNCTION

(75) Inventors: Yi-Guang Chen, Taipei (TW); Chien-Ming Ho, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/325,644

(22) Filed: Dec. 1, 2008

(30) Foreign Application Priority Data
Oct. 15, 2008 (TW) 097139466

(51) Int. Cl. G06F 3/033

(52) U.S. Cl. 345/166

(57) ABSTRACT

A mouse having a scrolling function includes a mouse body, an optical finger navigation module and a control unit. The optical finger navigation module is used for sensing a motion of a user's finger. The control unit controls a frame of a computer to be scrolled at an adjustable scrolling speed according to a moving speed of the user's finger.

### FIELD OF THE INVENTION

The present invention relates to a mouse, and more particularly to a mouse having a scrolling function.

### BACKGROUND OF THE INVENTION

A mouse device is an important bridge between a computer system and a user. In addition to the basic functions of controlling cursor movement, the mouse device is developed to execute extended functions.

For example, by rotating a scroll wheel of the mouse device forwardly or backwardly, a specified control signal is generated to control the vertical scroll movement of web pages. In addition to the vertical scroll movement, it is important to achieve the horizontal scroll movement. Since the texts or graphs shown on the graphic-based window of the display screen usually fail to be fully browsed, the horizontal scroll movement is required to move the web page or document in the left or right direction so as to display the desired image. Since the scroll wheel assembly of a conventional mouse device permits for single axial rotation, the image shown on the screen of the computer system may be vertically scrolled. For horizontally moving the web page or document shown on the screen by operating the scroll wheel, the left click button of the mouse device should be continuously pressed down and tilted in the horizontal direction. Since the single axial rotation of the mouse device is unsatisfactory for horizontal scroll movement, a tilt wheel assembly is developed for controlling horizontal scroll movement of the image shown on the computer screen.

Referring to FIG. 1, a schematic perspective view of a conventional tilt wheel type mouse is illustrated. The tilt wheel type mouse 1 includes a tilt wheel assembly 11. The tilt wheel assembly 11 can be rotated in a vertical direction 12 such that the image shown on the computer screen moves upwardly or downwardly. Moreover, the tilt wheel assembly 11 can be rotated in a horizontal direction 13 such that the image shown on the computer screen moves leftwards or rightwards. The arrangement of the tilt wheel assembly 11 is convenient for browsing documents or web pages.

Nowadays, with increasing development of digitalized technologies, text documents are gradually created as electronic files. As the data amounts of the electronic files are rapidly incased, the width and length of the documents or web pages are increased. Therefore, the speed of browsing the documents or web pages needs to be faster in order to save time. Although the tilt wheel type mouse has an automatic scrolling function for automatically scrolling the documents or web pages in the vertical or horizontal direction, there are still some drawbacks. For example, since the scrolling speed is constant, the conventional tilt wheel type mouse fails to meet the requirement of scrolling the documents or web pages at various speeds.

### SUMMARY OF THE INVENTION

It is an object of the present invention to provide a mouse having a scrolling function for scrolling an image on a screen at various scrolling speeds.

In accordance with an aspect of the present invention, there is provided a mouse having a scrolling function. The mouse is connected to a computer. The mouse includes a mouse body, an optical finger navigation module and a control unit. The optical finger navigation module is disposed on the mouse body for sensing a motion of a user's finger. The control unit is connected to the optical finger navigation module for scrolling a frame of the computer. The control unit controls the frame to be scrolled at an adjustable scrolling speed according to a moving speed of the user's finger.

In an embodiment, the optical finger navigation module includes a light source for emitting a light beam, a reflective mirror for reflecting the light beam onto the user's finger, a focusing lens for focusing the light beam that is reflected by the user's finger, a sensor for generating a sensing signal according to the focused light beam, and an upper cover for sheltering the optical element and penetrable by the light beam. The upper cover is exposed to a surface of the main body for allowing the user's finger to be placed thereon.

In an embodiment, a data amount of the sensing signal outputted from the sensor to the control unit is determined according to a moving speed of the user's finger on the optical finger navigation module.

In an embodiment, the control unit executes a first scrolling function if the data amount of the sensing signal outputted from the sensor to the control unit is greater than or equal to a threshold value, and the control unit executes a second scrolling function if the data amount of the sensing signal outputted from the sensor to the control unit is smaller than the threshold value.

In an embodiment, the frame is scrolled in a vertical direction at a first scrolling speed when the control unit executes the first scrolling function, and the frame is scrolled in the vertical direction at a second scrolling speed when the control unit executes the second scrolling function.

In an embodiment, the first scrolling speed and the second scrolling speed are greater than a preset vertical scrolling speed.

In an embodiment, the frame is scrolled in a horizontal direction at a first scrolling speed when the control unit executes the first scrolling function, and the frame is scrolled in the horizontal direction at a second scrolling speed when the control unit executes the second scrolling function.

In an embodiment, the first scrolling speed and the second scrolling speed are greater than a preset horizontal scrolling speed.

In an embodiment, the upper cover of the optical finger navigation module is made of transparent material.

In an embodiment, the control unit is a micro-controller.

In an embodiment, when the user's finger is moved on the optical finger navigation module a tilting direction, the control unit analyzes and obtains a vertical component and a horizontal component of a moving vector of the user's finger. If the vertical component is greater than the horizontal component, the control unit controls the frame of the computer to be scrolled a vertical direction. If the vertical component is smaller than the horizontal component, the control unit controls the frame of the computer to be scrolled a horizontal direction.

In an embodiment, the mouse further includes a mode-changing button. A two-dimensional scrolling function is enabled when the mode-changing button is activated.

In an embodiment, when the two-dimensional scrolling function is enabled, the control unit controls the frame to be scrolled in a tilting direction according to a tilting motion of the user's finger.

In an embodiment, the computer further includes a scrolling function driver program executed to enable or disable a two-dimensional scrolling function.

In an embodiment, when the two-dimensional scrolling function is enabled, the control unit controls the frame to be scrolled in a tilting direction according to a tilting motion of the user's finger.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional tilt wheel type mouse;

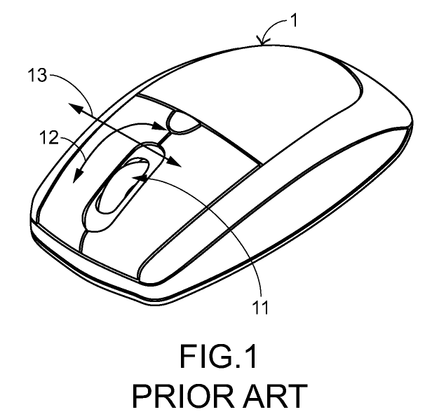

FIG. 2 is a schematic perspective view illustrating a mouse having a scrolling function according to a preferred embodiment of the present invention;

FIG. 3 is a schematic cross-sectional view illustrating the internal portion of an optical finger navigation module to be used in the mouse of the present invention;

FIG. 4 is a schematic view illustrating the mouse having a scrolling function to be used in a computer system according to a first preferred embodiment of the present invention t; and

FIG. 5 is a schematic view illustrating the mouse having a scrolling function to be used in a computer system according to a second preferred embodiment of the present invention.

### DETAILED DESCRIPTION OF THE PREFERRED EMBODIMENT

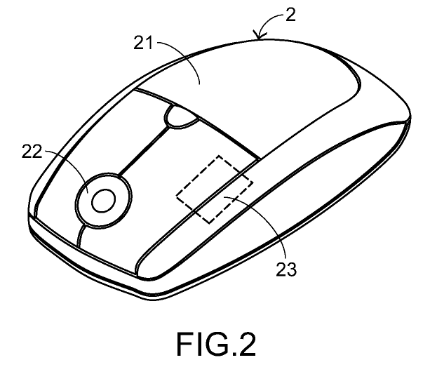

FIG. 2 is a schematic perspective view illustrating a mouse having a scrolling function according to a preferred embodiment of the present invention. As shown in FIG. 2, the scrolling-function mouse 2 of the present invention principally comprises a mouse body 21, an optical finger navigation (OFN) module 22 and a control unit 23. An example of the control unit 23 is a micro-controller. The optical finger navigation module 22 is disposed on the mouse body 21. In accordance with a key feature of the present invention, the optical finger navigation module 22 is arranged between the left click button and the right click button of the mouse body 21. The use of the optical finger navigation module 22 can replace the scroll wheel of a conventional wheel mouse. That is, the location of the optical finger navigation module 22 is equivalent to the location of the scroll wheel of a conventional wheel mouse. As a consequence, the user who habitually operates the scroll wheel can easily manipulate the optical finger navigation module 22 of the scrolling-function mouse 2. When the finger of a user is contacted with the optical finger navigation module 22 and moved on the optical finger navigation module 22, the optical finger navigation module 22 will execute a predetermined function according to the finger's movement.

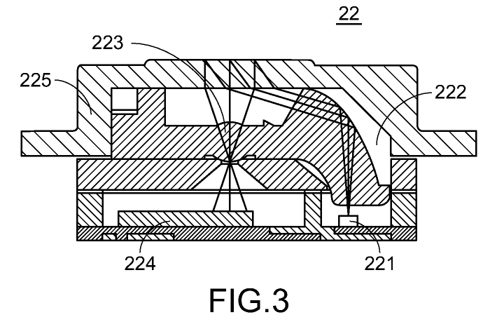

Hereinafter, the operations of the optical finger navigation module 22 that are based on optical theorems will be illustrated with reference to FIG. 3. FIG. 3 is a schematic cross-sectional view illustrating the internal portion of an optical finger navigation module to be used in the scrolling-function mouse of the present invention. As shown in FIG. 3, the optical finger navigation module 22 principally comprises a light source 221, a reflective mirror 222, a focusing lens 223, a sensor 224 and an upper cover 225. The light source 221 can emit a light beam. The light beam emitted by the light source 221 is reflected by the reflective mirror 222 and projected onto the upper cover 225. In a case that a user's finger is placed on the upper cover 225, the light beam that is reflected by the reflective mirror 222 will be reflected by the surface of the user's finger. The light beam reflected by the surface of the user's finger is focused by the focusing lens 223. The focused light beam is then received by the sensor 224 so as to be converted into a sensing signal. Moreover, since the upper cover 225 is made of transparent material, the light beam reflected by the reflective mirror 222 is penetrable through the upper cover 225 so as to be reflected by the surface of the user's finger.

By operating the optical finger navigation module 22, the scrolling-function mouse 2 of the present invention can execute the scrolling function of for example vertically scrolling a frame. Please refer to FIG. 3 again. The light beam emitted by the light source 221 is reflected by the reflective mirror 222 and projected onto the upper cover 225. In a case that a user's finger is placed on the upper cover 225, the light beam is reflected by the surface of the user's finger. The light beam reflected by the surface of the user's finger is focused by the focusing lens 223 and then received by the sensor 224. In receipt of the focused light beam, the sensor 224 detects information associated with the fingerprint of the user. According to a change of the fingerprint information, the sensor 224 generates a corresponding sensing signal.

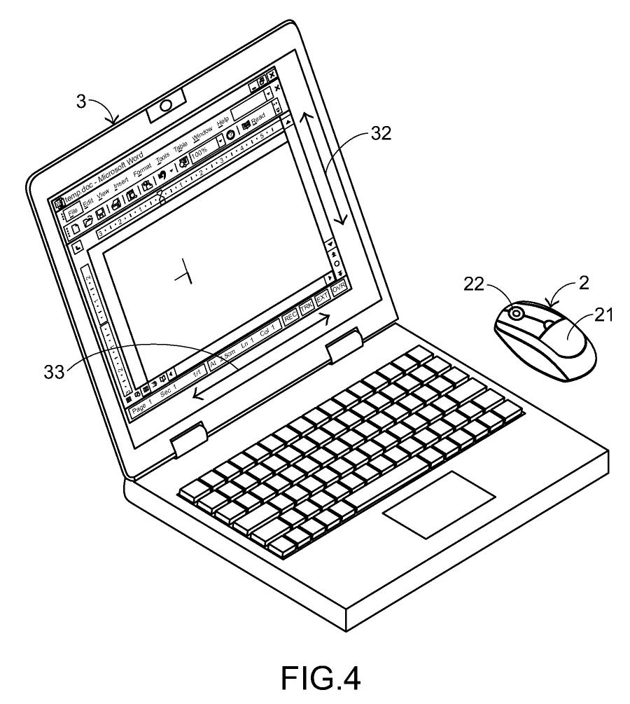

FIG. 4 is a schematic view illustrating the mouse having a scrolling function to be used in a computer system according to a first preferred embodiment of the present invention. As shown in FIG. 4, the scrolling-function mouse 2 is communicated with the computer system 3. When the user's finger is moved on the optical finger navigation module 22 (as shown in FIG. 3), the optical finger navigation module 22 will output a corresponding sensing signal to the control unit 23. For example, the sensing signal is indicative of a finger's moving vector. When the sensing signal is received by the control unit 23, the control unit 23 analyzes the finger's moving vector and figures out a vertical component and a horizontal component of the finger's moving vector. If the vertical component is greater than the horizontal component, the control unit 23 discriminates that the user's finger is vertically moved, so that a scrolling function is executed to scroll the frame of the computer 3 in a vertical direction 32. Whereas, if the vertical component is smaller than the horizontal component, the control unit 23 discriminates that the user's finger is horizontally moved, so that a scrolling function is executed to scroll the frame of the computer 3 in a horizontal direction 33. If the user's finger is continuously moved on the optical finger navigation module 22, the data amount of the sensing signals that are generated by the optical finger navigation module 22 and outputted to the control unit 23 is increased. In other words, as the speed of moving the user's finger is increased, the data amount of the sensing signals is increased. From the above description, the optical finger navigation module 22 is used to replace the scroll wheel of the conventional mouse so as to provide the functions of scrolling the frame in the vertical or horizontal direction.

Hereinafter, the use of the optical finger navigation module 22 to execute a high-speed scrolling function will be illustrated in more details.

Please refer to FIG. 2 again. In this embodiment, the optical finger navigation module 22 of the scrolling-function mouse 2 is also served as a mode-changing button. In addition, a switching element (not shown) is disposed within the mouse body 21 and under the optical finger navigation module 22. When the optical finger navigation module 22 is pressed down to touch the switching element, the mode-changing button is activated. In this embodiment, when the mode-changing button is activated, a two-dimensional scrolling function is enabled. Whereas, when the optical finger navigation module 22 is pressed down to touch the switching element again, the two-dimensional scrolling function is disabled. If the two-dimensional scrolling function is enabled, the frame of the computer 3 can be scrolled in the two-dimensional direction according to the moving direction of the user's finger. If the two-dimensional scrolling function is disabled, the frame of the computer 3 can be scrolled in either the vertical direction 32 or the horizontal direction 33 (as shown in FIG. 4).

Moreover, the scrolling-function mouse 2 of the present invention is capable of scrolling the frame at a high scrolling speed. In an embodiment, a first threshold value, a second threshold value and an application program are employed for determining the speed of scrolling the frame. It is preferred that the first threshold value, the second threshold value and the application program have been previously written into the control unit 23. The first threshold value and the second threshold value are both reference data amounts. When the user's finger is moved on the optical finger navigation module 22 at a moving speed higher than a normal moving speed, the data amount of the sensing signals outputted to the control unit 23 is increased because the moving speed of the user's finger is relatively higher. In a case that the data amount of the sensing signals generated by quickly moving the user's finger is greater than the first threshold value but smaller than the second threshold value, the control unit 23 executes a first scrolling function such that the frame is scrolled in the vertical direction 32 at a first scrolling speed. In another case that the data amount of the sensing signals is greater is greater than the second threshold value, the control unit 23 executes a second scrolling function such that the frame is scrolled in the vertical direction 32 at a second scrolling speed. The second scrolling speed is faster than the first scrolling speed.

When the high-speed scrolling function is executed, the user may browse the relatively large-sized web page or document. According to the user's requirements, the frame can be quickly scrolled at different scrolling speeds by changing the moving speeds of the user's finger. For example, according to the settings, ten lines per second are scrolled at the first scrolling speed and twenty lines per second are scrolled at the second scrolling speed. According to the user's requirements, more than two threshold values are employed for determining the scrolling speeds of the scrolling-function mouse 2 so as to increase the sensitivity of the optical finger navigation module 22.

In comparison with the conventional scroll wheel that moved in a single direction, the user's finger can be moved on the optical finger navigation module 22 in a two-dimensional direction to perform a two-dimensional scrolling function because the appearance of the optical finger navigation module 22 is substantially a circular platform.

Furthermore, after the mode-changing button is pressed down to enable the two-dimensional scrolling function, the control unit 23 will disable the high-speed scrolling function. Under this circumstance, the frame of the computer 3 can be scrolled in the vertical direction 32, the horizontal direction 33 or a tilting direction. In particular, after the two-dimensional scrolling function is enabled but the high-speed scrolling function is disabled, the control unit 23 will analyze the finger's moving vector and figure out a vertical component and a horizontal component of the finger's moving vector. According to the vertical component and the horizontal component of the finger's moving vector, the frame is scrolled in the tilting direction. For example, if the user's finger is moved on the optical finger navigation module 22 in a tilting direction of southeast 45 degrees, the control unit 23 will analyze the southeast-45-degree moving vector and figure out a vertical component and a horizontal component. Consequently, the frame is scrolled in the tilting direction. That is, the frame is moved in both the vertical direction and the horizontal direction according to the vertical component and the horizontal component. This two-dimensional scrolling function is feasible for viewing large-sized images such as engineering drawings or maps.

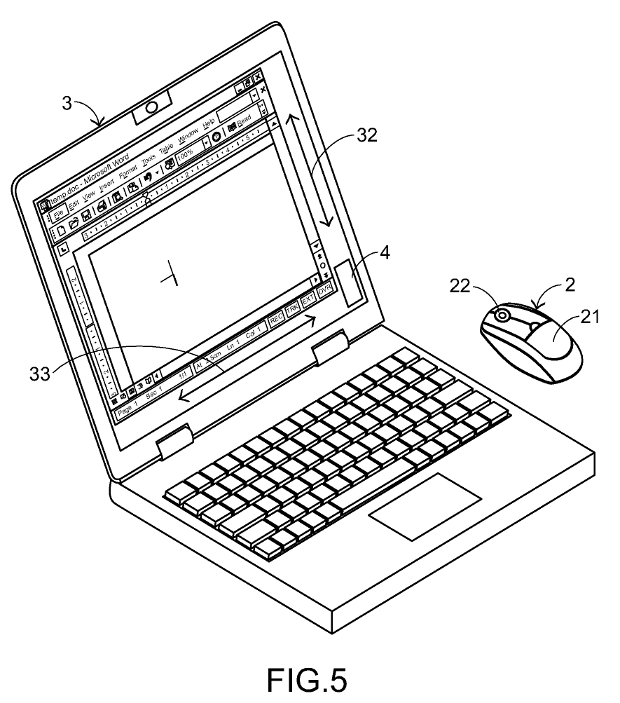

In the above embodiments, the two-dimensional scrolling function is selectively enabled or disabled by pressing down the mode-changing button. It is noted that, however, those skilled in the art will readily observe that numerous modifications and alterations may be made while retaining the teachings of the invention. FIG. 5 is a schematic view illustrating the mouse having a scrolling function to be used in a computer system according to a second preferred embodiment of the present invention. As shown in FIG. 5, the two-dimensional scrolling function is selectively enabled or disabled by installing a scrolling function driver program 4 into the computer 3. Via the user operating interface of the computer's operating system, the scrolling function driver program 4 is executed to control enabling or disabling of the two-dimensional scrolling function without the need of the mode-changing button. The two-dimensional scrolling function is similar to that described above, and is not redundantly described herein.

In the above embodiments, if the two-dimensional scrolling function is disabled, the frame of the computer 3 can be scrolled in either the vertical direction 32 or the horizontal direction 33 at various scrolling speeds (e.g. normal or high scrolling speeds). If the two-dimensional scrolling function is enabled, the frame can be scrolled in any direction (including the vertical direction and the horizontal direction) at the normal scrolling speed.

From the above description, the scrolling-function mouse of the present can scroll the frame at different scrolling speeds and perform the two-dimensional scrolling function in order to meet the diverse requirements and increase convenience.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse having a scrolling function, said mouse being connected to a computer and comprising:
a mouse body;
an optical finger navigation module disposed on said mouse body for sensing a motion of a user's finger; and
a control unit connected to said optical finger navigation module for scrolling a frame of said computer, wherein said control unit controls said frame to be scrolled at an adjustable scrolling speed according to a moving speed of said user's finger.

2. The mouse having a scrolling function according to claim 1 wherein said optical finger navigation module comprises:
a light source for emitting a light beam;
a reflective mirror for reflecting said light beam onto said user's finger;
a focusing lens for focusing said light beam that is reflected by said user's finger;
a sensor for generating a sensing signal according to said focused light beam; and
an upper cover for sheltering said optical element and penetrable by said light beam, wherein said upper cover is exposed to a surface of said main body for allowing said user's finger to be placed thereon.

3. The mouse having a scrolling function according to claim 2 wherein a data amount of said sensing signal outputted from said sensor to said control unit is determined according to a moving speed of said user's finger on said optical finger navigation module.

4. The mouse having a scrolling function according to claim 3 wherein said control unit executes a first scrolling function if said data amount of said sensing signal outputted from said sensor to said control unit is greater than or equal to a threshold value, and said control unit executes a second scrolling function if said data amount of said sensing signal outputted from said sensor to said control unit is smaller than said threshold value.

5. The mouse having a scrolling function according to claim 4 wherein said frame is scrolled in a vertical direction at a first scrolling speed when said control unit executes said first scrolling function, and said frame is scrolled in said vertical direction at a second scrolling speed when said control unit executes said second scrolling function.

6. The mouse having a scrolling function according to claim 5 wherein said first scrolling speed and said second scrolling speed are greater than a preset vertical scrolling speed.

7. The mouse having a scrolling function according to claim 4 wherein said frame is scrolled in a horizontal direction at a first scrolling speed when said control unit executes said first scrolling function, and said frame is scrolled in said horizontal direction at a second scrolling speed when said control unit executes said second scrolling function.

8. The mouse having a scrolling function according to claim 7 wherein said first scrolling speed and said second scrolling speed are greater than a preset horizontal scrolling speed.

9. The mouse having a scrolling function according to claim 2 wherein said upper cover of said optical finger navigation module is made of transparent material.

10. The mouse having a scrolling function according to claim 2 wherein said control unit is a micro-controller.

11. The mouse having a scrolling function according to claim 1 wherein when said user's finger is moved on said optical finger navigation module a tilting direction, said control unit analyzes and obtains a vertical component and a horizontal component of a moving vector of said user's finger, wherein if said vertical component is greater than said horizontal component, said control unit controls said frame of said computer to be scrolled a vertical direction, and if said vertical component is smaller than said horizontal component, said control unit controls said frame of said computer to be scrolled a horizontal direction.

12. The mouse having a scrolling function according to claim 1 further comprising a mode-changing button, wherein a two-dimensional scrolling function is enabled when said mode-changing button is activated.

13. The mouse having a scrolling function according to claim 12 wherein when said two-dimensional scrolling function is enabled, said control unit controls said frame to be scrolled in a tilting direction according to a tilting motion of said user's finger.

14. The mouse having a scrolling function according to claim 1 wherein said computer further comprises a scrolling function driver program executed to enable or disable a two-dimensional scrolling function.

15. The mouse having a scrolling function according to claim 14 wherein when said two-dimensional scrolling function is enabled, said control unit controls said frame to be scrolled in a tilting direction according to a tilting motion of said user's finger.
